(19) United States
(12) Patent Application Publication
(10) Pub. No.: US 2021/0404029 A1
(43) Pub. Date: Dec. 30, 2021

(54) HEAT TREATMENT INSTALLATION FOR PRODUCING SHAPED COMPONENTS

(71) Applicant: AICHELIN Holding GmbH, Mödling (AT)

(72) Inventor: Thomas DOPLER, Wien (AT)

(73) Assignee: AICHELIN Holding GmbH, Mödling (AT)

(21) Appl. No.: 17/333,987

(22) Filed: May 28, 2021

(30) Foreign Application Priority Data
Jun. 24, 2020 (DE) 102020116593.5

(51) Int. Cl. C21D 9/00; C21D 1/18; F27D 3/00; B65G 17/40

(52) U.S. Cl. CPC C21D 9/0062; C21D 1/18; C21D 2211/001; B65G 17/40; F27D 3/0024

(57) ABSTRACT

There are disclosed a heat treatment installation and a method of producing shaped components having at least two microstructural regions of different ductility or strength from semi-finished products of hardenable steel, using a continuous furnace which permits heating of the semi-finished products to a first temperature in a first region and permits heating of the semi-finished products to a second temperature, which differs from the first temperature, in a second region. The two regions are separated from one another by partition walls extending in the transport direction, and the continuous furnace includes a lifting-step chain conveyor as a transport device.

### CROSS REFERENCES TO RELATED APPLICATIONS

This application claims priority from German patent application 10 2020 116 593.5, filed on Jun. 24, 2020. The entire content of this priority application is incorporated herein by reference.

### BACKGROUND

The invention relates to a heat treatment installation for producing shaped components from semi-finished products of hardenable steel having at least two microstructural regions of different ductility or strength, using a continuous furnace which permits heating of the semi-finished products to a first temperature in a first region and permits heating of the semi-finished products to a second temperature in a second region, which differs from the first temperature, and having a hot-forming and/or hardening station for hot-forming and/or hardening the semi-finished products, the two regions being separated from one another by partition walls running in the transport direction.

The invention further relates to a method of producing shaped components from semi-finished products of hardenable steel having at least two microstructural regions of different ductility or strength.

DE 102 56 621 B3 discloses a method of producing a shaped component having at least two microstructural regions of different ductility, wherein a continuous furnace is used, wherein the semi-finished products to be heated simultaneously pass through at least two zones of the continuous furnace, which are arranged next to one another in the direction of passage, at different temperature levels during transport, whereby the semi-finished products are heated to different levels in the process, so that at least two microstructural regions of different ductility are produced in a subsequent hardening process. The continuous furnace used for this purpose, which is designed as a continuous roller-hearth furnace, has at least two zones which are adjacent to one another in the direction of passage and are separated from one another by a partition wall in such a way that a workpiece passing through the furnace is located partly within the first zone and partly within the second zone, wherein there is provided for separate temperature control in both zones.

Processes of a similar kind are known from DE 10 2010 048 209 C5, from DE 10 2016 201 024 A1, from DE 10 2016 201 936 A1, from US 7 540 993 B2 and from DE 10 2012 102 194 A1, wherein two microstructures of different ductility are produced in a shaped component by heating the component locally to different degrees, so that austenitization occurs in a first region of the component, but in a second region of the component an annealed structure is formed at least in part, so that different microstructures result during subsequent hot forming and/or hardening.

According to U.S. Pat. No. 7,540,993 the continuous furnace used for this purpose is designed as a roller-hearth furnace, which is heated electrically or by means of burners. Or a rotary hearth furnace is used.

According to DE 10 2012 102 194 A1 the component is supported on an insulating layer and radiant heat sources are provided on the side opposite the component. Alternatively, the component can also be placed on a roller arrangement to which radiant heat sources are assigned.

According to DE 10 2016 201 936 A1, a continuous furnace or a chamber furnace is used. In this case, the component is first austenitized, while subsequently the component is cooled in certain regions by blowing, for example using a gaseous fluid.

According to DE 10 2016 201 024 A1, the component is first austenitized in a first continuous furnace. Then the components are transferred to a second furnace with different regions, wherein cooling of the components takes place region by region.

According to DE 10 2010 048 209 C5 initially austenitization of the component is performed in a furnace. Subsequently, the component is removed from the furnace and cooled in one region by free convection, by cooling rolls, or by single-sided tempering plates with insulating counterlay, while another region of the component is actively kept at least at austenitizing temperature using external heat sources, or passively kept using appropriate insulation.

In this way, shaped components can be produced that have at least two microstructural regions of different ductility and strength. In this way, shaped components can be produced that have regions of different ductility and strength for special requirements, such as those encountered in automotive manufacturing. For example, a B-pillar or an A-pillar can be formed which is highly strong in a first region and more ductile and easier to form in another region.

According to DE 102 56 621 B3 the two zones or regions of the component are separated from each other by partition walls, so that the semifinished product in question can be treated at different temperatures in certain regions. Preferably, in this case, both a partition wall thermally insulating at the furnace ceiling is provided and a partition wall below the semi-finished product is provided, which in this case, however, can only be provided on a product carrier on which the semi-finished product is supported and which passes through the furnace together with the semi-finished product.

Such an arrangement is complicated, costly and error-prone.

If, on the other hand, a lower partition is used which is not fixed to a product support, the lower partition can only reach the roller conveyor from below, leaving a larger free space inside the roller conveyor which cannot be thermally insulated. This can have a correspondingly detrimental effect on the thermal separation of the two regions and thus on the microstructures produced.

Further, within a roller hearth it is difficult to align the microstructural regions to be treated precisely to particular geometrical regions of the semi-finished product which may lead to a bad performance of the final product during use.

### SUMMARY

In view of this it one aspect of the invention to disclose an improved heat treatment system for the production of shaped components with at least two microstructural regions of different ductility or strength leading to a simple and cost-effective production of shaped components with different microstructural regions.

It is another aspect of the invention to disclose an improved heat treatment system for the production of shaped components with at least two microstructural regions of different ductility or strength leading to an improved quality of the final components.

According to a first aspect of the invention there is disclosed a heat treatment installation for the production of shaped components from semi-finished products of hardenable steel, the components having at least two microstructural regions of different ductility or strength, the heat treatment installation comprising:
a continuous furnace comprising
a lifting-step chain conveyor for transporting semi-finished products in a transport direction through a furnace chamber;
at least one partition wall extending in said transport direction at least along a part of said furnace chamber, said partition wall dividing said furnace chamber into a first sub-chamber and into a second sub-chamber thermally divided from said first sub-chamber;
a heating system being configured for heating said first and second sub-chambers to different temperatures; and
a final treatment station configured for hot-forming or hardening semi-finished products after heating within said furnace chamber.

According to another aspect of the invention there is disclosed a method for producing shaped components with at least two microstructural regions of different ductility or strength from semi-finished products of hardenable steel, comprising the following steps:
placing the semi-finished products on a lifting-step chain conveyor in such a way that the semi-finished products lie partly in a first region and partly in a second region, the two regions being separated from one another by partition walls running in the transport direction;
conveying the semi-finished products through the two regions, the semi-finished products being maintained at austenitizing temperature in the first region and being maintained at a temperature for bainite formation in the second region;
hot-forming and/or hardening the semi-finished products thereafter.

The use of a lifting step chain conveyor makes it possible to bring the partition walls for separation between the two regions of different temperature particularly close to the semi-finished products to be treated, so that good thermal insulation results between the two regions and the transition between the two regions is very sharply delimited for the respective semi-finished products. In this way, particularly precise boundaries can be created between the microstructural regions with different hardness or ductility properties.

Another aspect of the lift-step chain conveyor is that no relative movements occur between the semi-finished products and the conveyor. Thus, no centering is required at the end of the heat treatment process before a handling device, such as a robot, takes over the semi-finished products and transfers them to the hot forming or hardening station.

According to the invention the regions of the semi-finished products are are heated to different temperatures can be positioned very precisely on the respective products thus leading to a precise geometrical placement of the different microstructures produced thereby. This is particularly due to the use of a continuous lifting-step chain conveyor hearth in contrast to a continuous roller hearth as common in the prior art.

According to a further aspect of the invention, the continuous furnace has a first zone for austenitizing the semi-finished products, in which no partition walls are provided, and a second zone, in which the two sub-chambers or regions with temperatures differing from each other are separated from each other by the partition walls running in the transport direction.

In this way, the structure of the continuous furnace is simplified, since in the first zone continuous heating of the furnace can take place over the entire width. Furthermore, a particularly uniform heating is made possible in the first zone.

According to another aspect of the invention, the first and second zones are separated from each other by upper and lower partition walls extending in the transport direction, between which a gap remains for the passage of a semi-finished product which can be moved by means of the lifting step chain conveyor.

Thus it is possible to make the gap as close as possible to the respective semi-finished product, so that a sharply delimited transition between the different microstructural regions that are subsequently produced is obtained.

According to a another aspect of the invention, the upper partition walls are adjustable in height, preferably by the upper partition walls being adjustably received on a furnace ceiling in the vertical direction.

In this way, the gap between the upper partition wall and the respective semi-finished product can be kept as small as possible.

According to another aspect of the invention, the lower partition walls terminate upwardly substantially at a level of a lower support surface of the lifting step chain conveyor. Here, the arrangement can be made such that the lower partition walls end approximately at a distance of 20 mm, preferably of 10 mm, further preferably of 5 mm, particularly preferably substantially at the level of the lower supporting surface of the lifting step chain conveyor.

In this way, the distance between the lower partition walls and the semi-finished product can be kept as small as possible, resulting in closely delimited transition regions between the various microstructural regions on the semi-finished product.

In addition, the lower partition walls may be designed to be adjustable in height.

According to another aspect of the invention, jacketed radiant tubes that can be heated or cooled are provided for heating the first and second regions.

Whereas in the prior art, for example according to DE 10 2010 048 209 C5, cooling rollers, single-sided tempering plates or other cooling devices are used for cooling, the use of jacketed radiant tubes that can be used for both heating and cooling enables the desired temperature to be achieved simply, inexpensively and very effectively. In particular, this allows easy cooling from a previously used higher austenitizing temperature to a lower temperature used for bainite formation, which may be in the range of about 450° C. to 600° C.

In accordance with another aspect of the invention, the lifting step chain conveyor comprises transport chains which are movably mounted on slide rails, wherein punches movable in the vertical direction are provided for holding the semi-finished products at an elevated level during a return movement of the transport chains.

According to another aspect of the invention the semi-finished products are first heated together to austenitizing temperature in a first zone of the continuous furnace and then brought to temperatures differing from one another in a subsequent second zone wherein the two sub-chambers are formed.

Here, the semi-finished products are preferably cooled in the second zone from an austenitizing temperature to a temperature for bainite formation.

In this way, a particularly simple and reliable process control is ensured.

According to another aspect of the invention, the semi-finished products are kept at a temperature of from 800° C. to 1000° C., preferably from 870 to 950° C., during austenitizing.

According to another aspect of the invention the semi-finished products are kept at a temperature of 200° C. to 600° C., preferably at a temperature of 450° C. to 600° C., in the second range. In this way, on the one hand, a high-strength microstructure can be achieved in one region of the semi-finished products by martensitic hardening, while in the other region, which is cooled to a temperature for bainite formation, bainitization is carried out, resulting in a more ductile microstructure after subsequent hot forming and/or hardening.

In this regard, the semi-finished products are preferably maintained at austenitizing temperature preferably in the range of 870° C. to 950° C. in both the first zone used for austenitization and the first sub-chamber of the second zone.

It is understood that the above features are usable not only in the respective combination indicated, but also in other combinations or independently, without departing from the scope of the invention.

### BRIEF DESCRIPTION OF THE DRAWINGS

Further features and advantages of the invention will be apparent from the following description of an embodiment with reference to the drawings. In the drawings show:

FIG. 1 an overall view of a heat treatment system according to the invention;:

FIG. 2 a section through the continuous furnace according to FIG. 1 along line II-II;

FIG. 3 a section through the continuous furnace according to FIG. 1 along the line III-Ill; and

FIG. 4 a detailed view of FIG. 3, from which the height-adjustable accommodation of the upper partition wall in the ceiling of the furnace can be seen.

### EMBODIMENTS

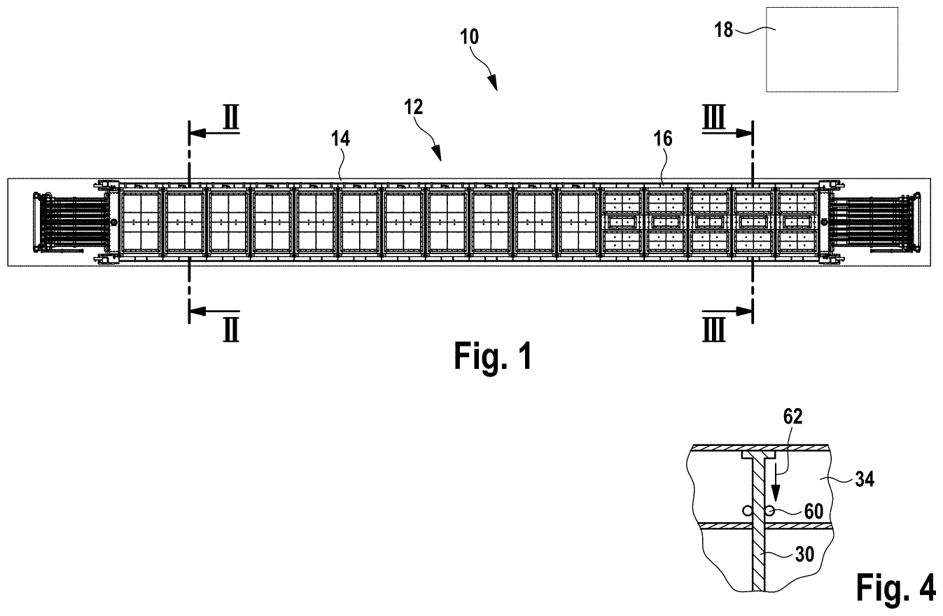

A heat treatment installation according to the invention is shown in FIG. 1 and designated overall by the numeral 10. The heat treatment installation 10 comprises a continuous furnace 12, as well as an associated hardening station 18, which is designed as a press hardening station.

The continuous furnace 12 has a continuous lift-step chain conveyor, the structure of which is explained in more detail below with reference to FIG. 3.

The continuous furnace 12 further has a first zone 14, which is provided for austenitization and which is followed by a second zone 16, in which two different regions or sub-chambers are created by thermally insulating partition walls running in the transport direction, so that different temperatures can be set in these sub-chambers.

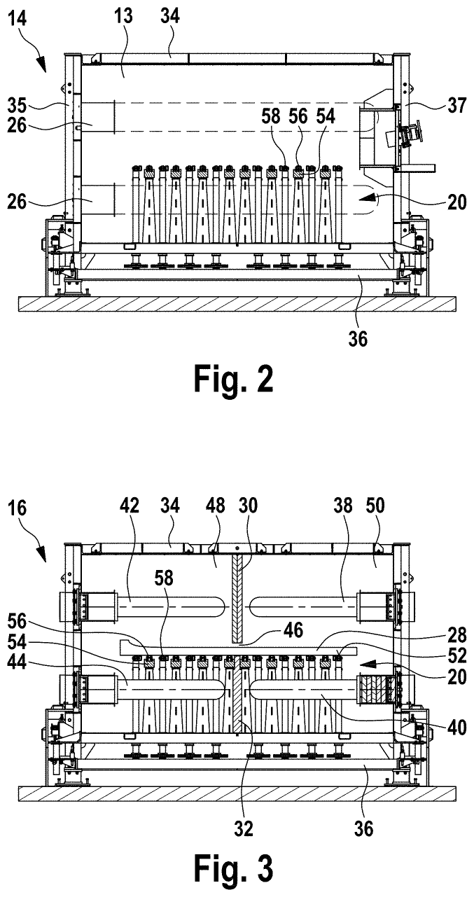

FIG. 2 shows a section through the continuous furnace 12 in the region of the first zone 14 along line II-II. In this region, the continuous furnace is not divided by thermally insulating partition walls in the transport direction or longitudinal direction. Thus, the furnace interior in this region can be heated continuously by means of suitable heating devices 26, for example gas or oil burners, to as uniform a temperature as possible, which is used for austenitizing. In FIG. 2, tubular heating elements 26 are indicated by dashed lines. The temperature in question for austenitizing depends, of course, on the material used in each case, on the throughput time, and also on the desired microstructure.

Generally, a range between 900° C. and 930° C. is preferred.

The furnace chamber 13 is bounded at the lower end by a furnace floor 36, at the upper end by a furnace roof 34, and at the sides by corresponding side walls 35 and 37. The conveyor 20 is designed as a lifting step chain conveyor of a basically known design, similar to that known, for example, from WO 2018/019920 A1.

The lifting-step chain conveyor 20 has transport chains 56 which are displaceably mounted on associated slide rails 54, wherein punches 58 which are displaceable in the vertical direction are provided for holding the semi-finished products during a return movement of the transport chains 56. The semi-finished products are moved by linear displacement over a step length in each case in the transport direction by means of the transport chains 58. Thereafter, the semi-finished products are lifted by means of the punches 58 movable in the vertical direction and the transport chains 58 are retracted to their initial position. Then the semi-finished products are lowered onto the transport chains 56 and transported further in a further transport step.

FIG. 3 shows a cross-section through the continuous furnace 12 in zone III-III according to FIG. 1. This is the second zone 16 of the continuous furnace, in which a separation in the transport direction is provided by thermally insulating partition walls for division into two different zones.

In FIG. 3, upper partition walls 30 and lower partition walls 32 can be seen. Exemplarily, a semi-finished product 28 in the form of a steel plate is shown resting on the lifting step chain conveyor 20 and extending through a gap formed between the upper partition walls 30 and the lower partition walls 32 into the two regions 48 on one side 48 and 50 on the other side.

In this regard, the lower partition wall 32 preferably extends to the level of the transport chains 58 so that the thermal separation between the two regions 48 and 50 extends from below directly to an overlying semi-finished product 28. The upper partition walls 30 are accommodated within the furnace roof 34 in a height-adjustable manner, as will be explained in more detail below with reference to FIG. 4.

Jacketed radiant tubes 38, 40, which project into sub-chamber 50 from one side, and 42, 44, which project into sub-chamber 48 from the other side, are used for heating.

These jacketed jet tubes 38, 40 and 42, 44, respectively, can be used for both heating and cooling. For cooling, a suitable cooling medium, e.g. cooling air, is passed therethrough.

By means of a combined heating or cooling option, a particularly precise temperature control can be ensured by means of the jacketed jet tubes 38, 40, 42, 44.

Preferably, one of the two regions, such as sub-chamber 48, continues to be maintained at austenitizing temperature, which can be approximately in the range of 870° C. to 950° C. The other sub-chamber 50 is used to cool the semi-finished products 28 to a temperature for bainite formation. The preferred temperature here is between 200° C. and 600° C., preferably in the range 450° C. to 600° C. The tubular elements 38, 40 in question are thus used in cooling mode in this range 50.

The upper partition walls 30 are accommodated within the furnace ceiling 34 so as to be adjustable in the vertical direction, as will be briefly explained in more detail with reference to FIG. 4. Since the furnace ceiling 34 has a thickness of the order of about 40 cm due to the thermal insulation, the upper end of the upper partition walls 30 can be suitably guided here, for example between a roller guide 60. In this way, an adjustability of the upper partition walls 30 of about just under 30 cm is made possible. Furthermore, suitable fixing means are provided to fix the upper partition walls 30 at a desired height (not shown).

In FIG. 4, the upper partition 30 is shown in its upper end position. From here, a downward displacement of the upper partition 30 in the direction of the arrow 62 is enabled.

What is claimed is:

1. A heat treatment installation for the production of shaped components from semi-finished products of hardenable steel, the components having at least two microstructural regions of different ductility or strength, the heat treatment installation comprising:
a continuous furnace comprising
a lifting-step chain conveyor for transporting semi-finished products in a transport direction through a furnace chamber, said lifting-step chain conveyor defining a lower supporting surface for said semi-finished products;
at least one upper partition wall extending in said transport direction at least along a part of said furnace chamber;
at least one lower partition wall extending in said transport direction at least along a part of said furnace chamber, said upper and lower partition walls dividing said furnace chamber into a first sub-chamber and into a second sub-chamber thermally divided from said first sub-chamber;
a heating system being configured for heating said first and second sub-chambers to different temperatures; and
a final treatment station configured for hot-forming or hardening semi-finished products after heating within said furnace chamber;
wherein said at least one lower partition wall ends at a distance of a maximum of 10 mm below said lower supporting surface.

2. The heat treatment installation of claim 1, further comprising a first zone without any partition walls being configured for austenitizing said semi-finished products, and a second zone, wherein said first and second sub-chambers are provided separated from one another by said partition walls.

3. The heat treatment installation of claim 1, wherein said at least one upper partition wall is adjustable in height.

4. The heat treatment installation of claim 1, wherein said heating system is configured for heating and cooling said first and second sub-chambers.

5. The heat treatment installation of claim 4, wherein said heating system comprises jacket radiant tubes being configured for heating and cooling said first and second sub-chambers.

6. The heat treatment installation according to claim 1, wherein said at least one lower partition wall is adjustable in height.

7. The heat treatment installation of claim 1, wherein said lifting-step chain conveyor comprises transport chains which are mounted displaceably on rollers, wherein said transport chains define said lower supporting surface, and further comprises punches arranged displaceably in a vertical direction for holding semi-finished products at an elevated level during a return movement of said transport chains.

8. The heat treatment installation of claim 1, wherein said at least one lower partition wall ends upwardly substantially at a level of a supporting surface of said lifting-step chain conveyor drive.

9. A heat treatment installation for the production of shaped components from semi-finished products of hardenable steel, the components having at least two microstructural regions of different ductility or strength, the heat treatment installation comprising:
a continuous furnace comprising
a lifting-step chain conveyor for transporting semi-finished products in a transport direction through a furnace chamber;
at least one partition wall extending in said transport direction at least along a part of said furnace chamber, said partition wall dividing said furnace chamber into a first sub-chamber and into a second sub-chamber thermally divided from said first sub-chamber;
a heating system being configured for heating and cooling said first and second sub-chambers to different temperatures; and
a final treatment station configured for hot-forming or hardening semi-finished products after heating within said furnace chamber.

10. The heat treatment installation of claim 9, further comprising a first zone being configured for austenitizing the semi-finished products without any partition walls, and a second zone, wherein said first and second sub-chambers are provided separated from one another by said partition walls.

11. The heat treatment installation of claim 9, wherein said first and second sub-chambers are separated from each other by upper and lower partition walls extending in said transport direction, between which a gap remains for passing semi-finished products therethrough.

12. The heat treatment installation of claim 11, wherein said at least one upper partition wall is adjustable in height.

13. The heat treatment installation of claim 11, wherein said at least one lower partition wall ends at a distance of no more than 5 mm below a level of a lower supporting surface of said lifting-step chain conveyor.

14. The heat treatment installation of claim 11, wherein said at least one lower partition wall ends upwardly substantially at a level of a supporting surface of said lifting-step chain conveyor drive.

15. The heat treatment installation according to claim 11, wherein said at least one lower partition wall is adjustable in height.

16. The heat treatment installation of claim 9, wherein said heating system comprises jacket radiant tubes being configured for heating and cooling said first and second sub-chambers.

17. The heat treatment installation of claim 9, wherein said lifting-step chain conveyor comprises transport chains which are mounted displaceably on rollers, and further comprises punches arranged displaceably in a vertical direction for holding semi-finished products at an elevated level during a return movement of said transport chains.

18. A heat treatment installation for the production of shaped components from semi-finished products of hardenable steel, the components having at least two microstructural regions of different ductility or strength, the heat treatment installation comprising:
a continuous furnace comprising
a lifting-step chain conveyor for transporting semi-finished products in a transport direction through a furnace chamber;
at least one partition wall extending in said transport direction at least along a part of said furnace chamber, said partition wall dividing said furnace chamber into a first sub-chamber and into a second sub-chamber thermally divided from said first sub-chamber;
a heating system being configured for heating said first and second sub-chambers to different temperatures; and
a final treatment station configured for hot-forming or hardening semi-finished products after heating within said furnace chamber.

19. The heat treatment installation of claim 18, further comprising a first zone being configured for austenitizing the semi-finished products without any partition walls, and a second zone, wherein said first and second sub-chambers are provided separated from one another by said partition walls.

20. The heat treatment installation of claim 18, wherein said first and second sub-chambers are separated from each other by upper and lower partition walls extending in said transport direction, between which a gap remains for passing semi-finished products therethrough, wherein at least one of said at least one upper and lower partition walls is adjustable in height.
